(19) United States
(12) Patent Application Publication
(10) Pub. No.: US 2013/0178364 A1
(43) Pub. Date: Jul. 11, 2013

(54) Odor mitigating fumigant composition

(71) Applicants: John Stephen Godbehere, Ochlocknee, GA (US); Dean Calvin Storkan, Monterey, CA (US)

(72) Inventors: John Stephen Godbehere, Ochlocknee, GA (US); Dean Calvin Storkan, Monterey, CA (US)

(21) Appl. No.: 13/374,664

(22) Filed: Jan. 5, 2012

(51) Int. Cl. A01N 41/12; A01P 5/00; A01P 13/00; A01P 1/00

(52) U.S. Cl. 504/118

(57) ABSTRACT

An odor mitigating agricultural fumigant includes a mixture of DMDS and 1,3-dichloropropene, which is added to the mixture as an ingredient of Telone® or Telone II®. This mixture significantly reduces the Mercaptan-like odor that normally accompanies Paladin® (DMDS) and Paladin® based mixtures.

### FIELD OF THE INVENTION

This invention relates to an agricultural fumigant composition that mitigates the offensive Mercaptan-like odor that conventionally accompanies the use of dimethyl disulfide (DMDS) in the US EPA registered soil fumigant Paladin® and Paladin® mixtures.

### BACKGROUND OF THE INVENTION

Methyl bromide (MBr) has been used as a soil fumigant since the mid 1900's to control a broad-spectrum of pests including weeds, diseases, and nematodes. Because of its effectiveness, it was readily adopted for use on many high value crops including vegetables, fruits and ornamentals. In 1987, the Montreal Protocol defined MBr as a Class 1 ozone depleting substance. Accordingly, the manufacture of MBr and its importation to developed countries have since been phased-out. In 2006 the US Environmental Protection Agency (EPA) began a critical use exemption (CUE) process that permits the use of MBr in the instance where there are no technically, environmentally or economically effective alternatives available to the user. Although limited quantities of MBr are currently available, the increased cost of MBr resulting from the reduced supply has limited its economic feasibility.

Accordingly, extensive research has been conducted to develop more environmentally acceptable fumigants. In particular, the use of dimethyl disulfide (DMDS), both alone and in combination with other active ingredients, has recently received full federal registration from the US Environmental Protection Agency. DMDS is a principal component in certain fumigants registered for pre-plant use in connection with various fruits, vegetables, ornamentals and forest nursery crops. Mixtures of DMDS and chloropicrin are an effective combination to control nematodes, plant pathogens and assorted types of weeds, including yellow and purple nutsedge. Nutsedge species have been the single greatest pest management challenge for replacing MBr.

Although DMDS, both alone and in mixture with chloropicrin, has been established as an effective alternative to MBr, DMDS, in particular, produces an extremely offensive odor that can linger for days after the fumigant is applied. The particular odor associated with DMDS is Mercaptan-like. Mercaptan is the warning odorant added to liquid propane and natural gas, and which the general public associates with a gas leak. This odor hampers and limits use of DMDS because of bystander displeasure. Additionally, whereas methyl bromide has a history of use with non-tarp fumigant applications, the low threshold for odor detection of DMDS precludes the use of Paladin® or Paladin® containing mixtures in non-tarp applications. Until this odor problem is successfully addressed, it is likely that the potential benefits of using DMDS as a MBr substitute will not be fully realized. Various perfumes and odor masking agents have been mixed with DMDS but the results to date have been disappointing.

### SUMMARY OF THE INVENTION

It is therefore an object of the present invention to provide an agricultural fumigant that effectively mitigates the distasteful and lingering odor that normally accompanies the use of DMDS and which therefore allows greater and more effective use of this fumigant, thus allowing significantly improved domestic production of fresh fruits, vegetables, forest nursery seedlings and other high value crops that could become in short supply to the US consumer due to the limited availability of MBr.

It is a further object of this invention to provide an odor mitigating soil fumigant that facilitates the substitution of DMDS for environmentally unfriendly MBr and that can be applied directly with current equipment used to apply MBr mixtures.

It is a further object of this invention to provide an odor mitigating composition that may be used effectively as a soil fumigant in a wide variety of pre-plant applications for controlling nematodes and other sub-soil pests.

It is a further object of this invention to provide an odor mitigating soil fumigant that can be used via the non-tarp method both by sub-soil shank injection and through the sub-soil drip tape injection method.

This invention results from a realization that the foul and lingering odor that normally accompanies the use of DMDS as a fumigant may be largely mitigated in an extremely cost efficient manner by mixing DMDS with either of the compounds Telone® or Telone II®, which comprise a high concentration of the active ingredient 1,3-dichloropropene. A product comprising a mixture of 1,3-dichloropropene and DMDS in solution exhibits a favorable efficacy in eradicating or suppressing many soil borne pathogens, nematodes, weeds and other problematic pests without producing a foul and lingering odor which is normally produced by DMDS alone. By the same token, the composition provides for an effective substitute for fumigants employing ozone depleting MBr.

This invention features an agricultural fumigant including a solution of liquid compounds respectively including DMDS and 1,3-dichloropropene. In a preferred embodiment, the required 1,3-dichloropropene component is introduced into the mixture as a constituent of the compounds Telone® or Telone II®. Various concentrations of the respective ingredients may be employed in the mixture. The compound comprising DMDS each may vary from 25%-85% by weight. The concentration of the compound comprising 1,3-dichloropropene may vary from 5%-75%.

The foregoing constituents are mixed in liquid form in solution and injected through conventional methyl bromide application equipment without an emulsifying agent or injected into a pre-formed and mulched bed or through buried drip tape used in non-tarped culture, through a drip irrigation application with the aid of an emulsifying agent. The applied mixture significantly reduces the offensive odor normally emitted by the DMDS fumigant. At the same time, the efficacy of the fumigant solution equals or surpasses that of conventional DMDS fumigant compositions.

### DETAILED DESCRIPTION OF PREFERRED EMBODIMENTS

An odor mitigating agricultural fumigant according to this invention includes a mixture of two compounds respectively comprising DMDS and 1,3-dichloropropene in solution. The latter is preferably introduced in the form of Telone® or Telone II®, which are conventionally used as nematacides and, except as disclosed in copending application Ser. No. 13,317,069, have not heretofore been employed in combination with DMDS for odor mitigation or for increased efficacy. Telone II® includes 97.5% 1,3-dichloropropene as its active ingredient, as well as additional inactive ingredients in accordance with the current EPA registration of that product. Telone® or Telone II® are preferred because they are the most readily available and cost efficient source of highly concentrated 1,3-dichloropropene. Obtaining a pure, unadulterated supply of this constituent is unduly complicated and expensive. Simply employing available Telone®/Telone II® facilitates and reduces the cost of manufacturing the fumigant considerably. By the same token, DMDS is added to the solution in the form of commercially available Paladin®, which is comprised of 98.5% concentration of the active ingredient DMDS or Paladin® Technical, which is comprised of 99.0% concentration of the active ingredient DMDS.

The composition is mixed within an application cylinder at a formulation facility. The respective constituents are mixed in liquid form to produce a fumigant solution. The individual DMDS and 1,3-dichloropropene constituent compounds may have concentrations within ranges of approximately 25%-85% and 15%-75% respectively. Constituent concentrations within the foregoing ranges provide for acceptable odor mitigation when the solution is applied as a fumigant in various agricultural applications.

The resulting fumigant solution is applied to either a cultivated field before the crops are planted (pre-plant) or an agricultural environment where undesirable weeds and/or pathogens must be eliminated. The solution is injected or otherwise applied to the site using conventional fumigant application techniques and equipment that will be known to persons skilled in the art. The fumigant solution may be applied with an overlying tarp covering the planting site or in the absence of a tarp. Drip injection application may also be used. The solution is applied in the absence of an emulsifying agent and not as a part of an emulsion in the shank injection method. The drip injection method requires the addition of an emulsifier to the solution. In either case, the fumigant is applied without the distasteful and lingering odor that conventionally accompanies the application of DMDS as an active ingredient in known fumigants. The mixture of DMDS, chloropicrin and 1,3-dichloropropene mitigates this offensive smell while performing highly effective fumigation. As a result, the application of fumigants utilizing DMDS greatly is facilitated and the user is much more apt to utilize the otherwise malodorous DMDS as a fumigant. The use of MBr and its adverse environmental effects are thereby avoided.

The foregoing results were very unexpected, as each of DMDS and 1,3-dichloropropene exhibits a strong, sharp and/or irritating odor when used alone as a fumigant or when combined with other fumigants as disclosed by the prior art. However, when these compounds are mixed with respective concentrations of 25%-85% by weight for the DMDS and 15%-75% for the 1,3-dichloropropene containing compound, the irritating and offensive odor is effectively mitigated in accordance with this invention. In addition, the present invention eliminates the need to use odor washing agents and the additional efforts and expense associated therewith. Currently, the areas where DMDS can be used in a soil fumigant mixture are limited by the potential of odor complaints that could result from people living, working, or traveling nearby the application site. Accordingly, farmers or commercial fumigant applicators will only apply DMDS mixtures in very remote locations to avoid odor complaints by neighbors. This invention allows the use of DMDS as a component of a soil fumigant mixture on many more fields thus enabling the increased production of fruits, vegetables, and forest nursery seedlings in closer proximity to retail markets. This invention will also allow the use of Paladin® in non-tarp situations in row crops such as cotton, peanuts, sweet corn, sugar beets, etc. and in horticultural crops such as orchard replant, ornamentals, or forest nursery seedling production where broad spectrum nematode control is warranted between soil tarp fumigations.

The concentrations of the respective constituents may be adjusted within the ranges set forth above to address various concerns and for designed fumigant applications. Various formulas of this mixture may be used as needed to address pest level (pathogens, diseases, nematodes, and weeds) changes in response to cropping history, geography, environmental conditions, soil types, and pathogen distribution. Historically, the most commonly used fumigants have been developed to include formulations with varying mixtures, which allows producers to match a specific formulation with a specific production system.

Results from the foregoing test and other ongoing studies have determined that, in each instance, the mixture of DMDS and 1,3-dichloropropene in solution is a consistently effective alternative to MBr. Weed, pest and disease control is as effective as, if not superior to, the control provided by the previously available DMDS based products.

Accordingly, this invention relates to an odor mitigating agricultural fumigant composition wherein 1,3-dichloropropene, preferably as a constituent of Telone®/Telone II®, is combined with a DMDS based compound such as Paladin® to effectively mitigate the odor normally produced by DMDS alone or DMDS mixtures. At the same time, the combination achieves a superior efficacy for use in a variety of fumigant applications while utilizing the same equipment used by growers and fumigation applicators for applying MBr fumigants.

What is claimed is:

1. An agricultural fumigant comprising first and second liquid compounds mixed in solution, said first compound including dimethyl disulfide and having a concentration of 25%-85% by weight and said second compound including 1,3-dichloropropene and having a concentration of 15%-75% by weight.

2. The fumigant of claim 1 in which said second compound comprises at least one of Telone® and Telone II®.

3. The fumigant of claim 1 in which said first compound consists of Paladin®.

4. A method of manufacturing and applying a dimethyl disulfide based plant fumigant and mitigating the offensive odor that normally accompanies the application of dimethyl disulfide, said method comprising:
mixing first and second liquid fumigant compounds to form a fumigant solution, said first compound including dimethyl disulfide and having a concentration of 25%-85% by weight, and said second compound including 1,3-dichloropropene and having a concentration of 15%-75% by weight; and
applying said fumigant solution to a planting site to fumigate the site and mitigate the odor exhibited individually by said first and second liquid fumigant compounds.

5. The method of claim 4 in which said fumigant solution is applied to the planting site by one of tarped, non-tarped and drip methods of soil fumigation.

6. The method of claim 4 in which said second compound comprises at least one of Telone® and Telone II®.

7. The method of claim 4 in which said first compound consists of Paladin®.
